(19) United States
(12) Patent Application Publication
(10) Pub. No.: US 2008/0090160 A1
(43) Pub. Date: Apr. 17, 2008

(54) Alignment for contact lithography

(76) Inventors: Jason Blackstock, Palo Alto, CA (US); Wei Wu, Palo Alto, CA (US); Zhiyong Li, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/580,639

(22) Filed: Oct. 13, 2006

(51) Int. Cl. G03C 5/00

(52) U.S. Cl. 430/30

(57) ABSTRACT

A contact lithography system includes a patterning tool having a pattern for transfer to a substrate; and a sensor disposed on the patterning tool for sensing a magnetic pattern disposed on the substrate to determine alignment between the patterning tool and the substrate. A method of aligning a patterning tool of a contact lithography system with a substrate includes detecting a pattern of magnetic material on the substrate with a sensor on the patterning tool to determine alignment of the patterning tool with respect to the substrate.

### BACKGROUND

Contact lithography involves direct contact between a patterning tool (e.g., a mask, mold, template, etc.) and a substrate on which micro-scale and/or nano-scale structures are to be fabricated. Photographic contact lithography and imprint lithography are two examples of contact lithography methodologies.

In photographic contact lithography, the patterning tool (i.e., the mask) is aligned with and then brought into contact with the substrate or with a pattern-receiving layer of the substrate. Some form of light or radiation is then used to expose those portions of the substrate that are not covered by the mask so as to transfer the pattern of the mask to the pattern-receiving layer of the substrate. Similarly, in imprint lithography, the patterning tool (i.e., the mold) is aligned with the substrate after which the mold is pressed into the substrate such that the pattern of the mold is imprinted on, or impressed into, a receiving surface of the substrate.

With either method, alignment between the patterning tool and the substrate is very important. The method for aligning the patterning tool and substrate generally involves holding the patterning tool a small distance above the substrate while relative lateral and rotational adjustments (e.g., x-y translation and/or angular rotation adjustments) are made. Either the patterning tool or the substrate, or both, may be moved during the process of alignment. The patterning tool is then brought into contact with the substrate to perform the lithographic patterning.

As will be appreciated, the alignment between the patterning tool and the substrate must be very precise given the micro-scale or nano-scale structures being formed by these lithographic techniques. Any of a wide number of factors can cause misalignment that may, even if only minor, be detrimental to the operation of the device being fabricated. For example, there may be some vibration of the patterning tool and/or substrate during the alignment process. This vibration also affects systems, usually optical systems, that are used to measure or verify the alignment between the patterning tool and the substrate. The vibrations experienced by such alignment measuring systems are generally not consistent with the vibrations experienced by the patterning tool and substrate being measured.

Since alignment equipment often experiences vibrations substantially different from those of the patterning tool and substrate, it becomes difficult to accurately measure and adjust alignment. For example, a microscope for detecting the alignment of a patterning tool and substrate experiences vibrations different from those experienced by the patterning tool and substrate. The differential vibrations blur the image captured by the microscope and consequently decrease the sensitivity of alignment measurements making it difficult to ensure accurate alignment between the patterning tool and substrate.

### BRIEF DESCRIPTION OF THE DRAWINGS

The accompanying drawings illustrate various embodiments of the principles being described in this specification and are a part of the specification. The illustrated embodiments are merely examples and do not limit the scope of the principles described herein.

FIG. 1A is a schematic side view of a contact lithography apparatus that forms a pattern of magnetic material on a substrate that can be used to subsequently align a patterning tool with the substrate, according to one exemplary embodiment.

FIG. 1B is a schematic side view of a contact lithography apparatus that also forms a pattern of magnetic material on a substrate using a different technique. Again, the pattern of magnetic material can be used to subsequently align a patterning tool with the substrate, according to one exemplary embodiment.

FIG. 2A is a schematic side view of a substrate undergoing contact lithography following the formation of a magnetic alignment pattern, according to one exemplary embodiment.

FIG. 2B is a schematic side view of a substrate undergoing contact lithography following the formation of a magnetic alignment pattern and an additional patterning material layer, according to one exemplary embodiment.

FIG. 3 is a schematic side view of a contact lithography apparatus that is using a pattern of magnetic material on a substrate to align a contact lithography patterning tool with the substrate, according to one exemplary embodiment.

FIG. 4 is a flowchart illustrating a process of fabricating a multi-layer structure using a contact lithography processes that aligns a patterning tool for each layer using a pattern of magnetic material formed on the substrate, according to one exemplary embodiment.

Throughout the drawings, identical reference numbers designate similar, but not necessarily identical, elements.

### DETAILED DESCRIPTION

The present specification describes exemplary methods and systems that facilitate alignment of a patterning tool and a substrate for contact lithography. To improve the accuracy, precision, and vibration tolerance of the alignment between the patterning tool and substrate, a pattern of magnetic material is formed on the substrate while a magnetic sensor capable of detecting the pattern of magnetic material is integrated with the patterning tool, e.g., a mold or mask.

Additionally, in some examples, multiple layers of structure are created on top of each other using contact lithography with alignment of a patterning tool and the substrate being performed for each such layer using the pattern of magnetic material and the magnetic sensor. It will be readily appreciated that the alignment of the patterning tool for each such layer with the substrate and any preceding layers is very important to the ultimate quality and reliability of the device being fabricated.

As used herein and in the appended claims, the term “contact lithography” generally refers to any lithographic methodology that employs a direct or physical contact between a patterning tool or means for providing a pattern and a substrate or means for receiving the pattern, including a substrate having a pattern receiving layer thereon. Specifically, “contact lithography” as used herein includes, but is not limited to, any form of imprint lithography or photographic contact lithography.

As mentioned above, and by way of example, in imprint lithography, the patterning tool is a mold that transfers a pattern to the substrate through an imprinting process. In some embodiments, physical contact between the mold and a layer of formable or imprintable material on the substrate transfers the pattern to the substrate. Imprint lithography, as well as a variety of applicable imprinting materials, are described in U.S. Pat. No. 6,294,450 to Chen et al. and U.S. Pat. No. 6,482,742 B1 to Chou, both of which are incorporated herein by reference in their respective entireties.

In photographic contact lithography, a physical contact is established between a patterning tool, in this case called a photomask or, more simply, a mask, and a photosensitive resist layer on the substrate that serves as the pattern receiving layer. During the physical contact, visible light, ultraviolet (UV) light, or another form of radiation passing through selected portions of the photomask exposes the photosensitive resist or photoresist layer on the substrate. The photoresist layer is then developed to remove portions that don't correspond to the pattern. As a result, the pattern of the photomask is transferred to the substrate.

For simplicity in the following discussion, no distinction is generally made between the substrate and any layer or structure on the substrate (e.g., a photoresist layer or imprintable material layer) unless such a distinction is helpful to the explanation. Consequently, reference herein is generally to the “substrate” irrespective of whether a resist layer or an imprintable material layer is or is not employed on the substrate to receive the pattern. One of ordinary skill in the art will appreciate that a resist or imprintable material layer may always be employed on the substrate of any contact lithography methodology according to the principles being described herein.

Further, as used herein and in the appended claims, the term “deformation” refers to both a plastic deformation and an elastic deformation. As used herein, “plastic deformation” means an essentially non-reversible, non-recoverable, permanent change in shape in response to an applied force. For example, a “plastic deformation” includes a deformation resulting from a brittle fracture of a material under normal stress (e.g., a cracking or shattering of glass) as well as plastic deformations that occur during shear stress (e.g., bending of steel or molding of clay). Also, as used herein, “elastic deformation” means a change in shape in response to an applied force where the change in shape is essentially temporary and/or generally reversible upon removal of the force.

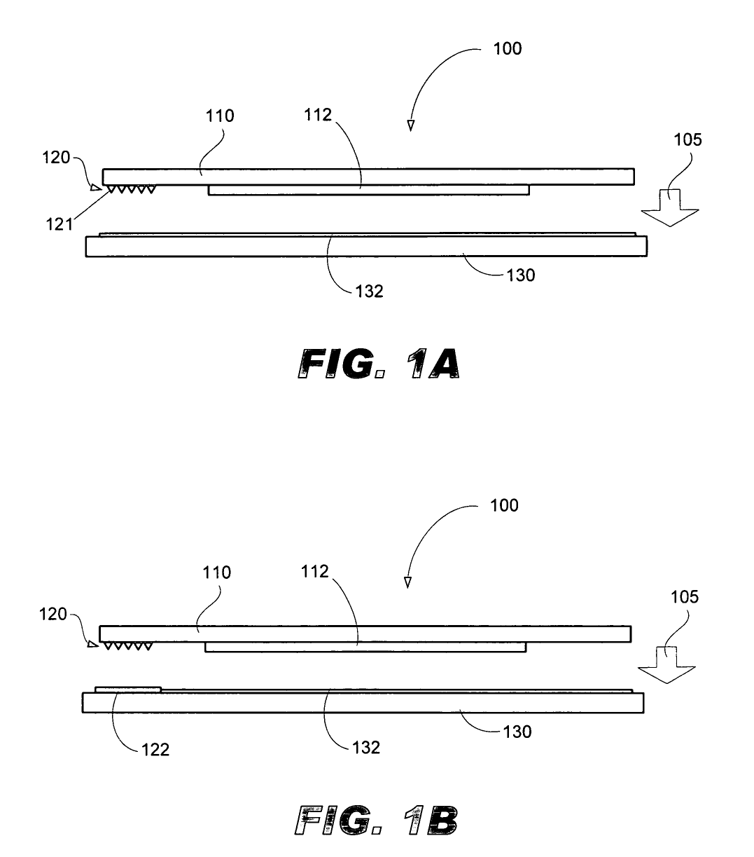

FIG. 1A is a schematic side view of a contact lithography apparatus that also forms a pattern of magnetic material on a substrate. This pattern of magnetic material can then be used to subsequently align a patterning tool, such as a mold, with the substrate, according to one exemplary embodiment. In the example of FIG. 1A, the contact lithography apparatus shown is an imprint lithography system and the patterning tool is, consequently, a mold.

As shown in FIG. 1A, a substrate (130) is prepared to receive an imprinted pattern from a mold (110). The mold (110) includes a physical relief pattern (112) that is imprinted or stamped onto or into a surface (132) of the substrate (130) so as to form a structure corresponding to the pattern (112) on the substrate (130).

The surface (132) of the substrate that receives the pattern may be a natural surface of the substrate (130) or may be a layer of material deposited on the substrate (130) specifically to receive the pattern of the mold (110). The arrow (105) represents the action of applying pressure between the mold (112) and the substrate (130) to from a desired structure on the substrate (130) corresponding to the main pattern (112) of the mold (110).

On the left side of the mold (110), as illustrated in FIG. 1, is an additional imprint feature or stamp (120) for forming an additional relief pattern in the substrate (130) by plastic deformation. In at least some examples, this additional pattern will be outside the area imprinted by the main pattern (112) on the mold (110) and will be on the periphery of the substrate (130). This additional pattern is formed using magnetic material, as will be described in more detail below.

In the example of FIG. 1A, a magnetic material (121) is loaded onto the additional imprint feature (120) of the mold (110). Consequently, when the mold (110) is brought forcefully into contact with the substrate (130), as indicated by the arrow (105), the pattern (112) forms a desired structure on the substrate (130) and the additional imprint feature (120) stamps an additional pattern into the substrate (130) by plastic deformation.

As this occurs, the magnetic material (121) loaded onto the additional imprint feature (120) is embedded in the corresponding pattern formed on the substrate (130). In this way, a pattern of magnetic material is formed on the substrate (130) which will be used to align subsequent molds with the substrate (130) as will be described in more detail below.

In this example, the pattern of magnetic material is formed on the substrate (130) at the same time that the mold (110) imprints the main pattern (112) into the substrate (130). Consequently, the pattern of magnetic material is then particularly useful, as will be described below, for aligning subsequent molds that form subsequent layers of structure with the substrate (130) and the structure previously formed on the substrate (130) by the first mold (110) or succeeding molds. As will be appreciated by those skilled in the art, relatively alignment between a first and subsequent patterns transferred or imprinted to the substrate (130) is very important, perhaps more important than the initial alignment of the substrate (130) with a first mold (110) forming a first layer of structure.

FIG. 1B is a schematic side view of a contact lithography apparatus that also forms a pattern of magnetic material on a substrate using a different technique. In the example above, magnetic material is loaded on the mold and then transferred to the substrate as patterns are formed on the substrate. Additionally or alternatively, there may be magnetic material already disposed on the substrate that is imprinted to produce the desired pattern of magnetic material that can be used for subsequent alignment operations.

As shown in FIG. 1B, a pad of magnetic material (122) is formed on the substrate (130). This magnetic material (122) is formed at the location where the desired pattern of magnetic material is to be disposed for alignment operations. As indicated above, this may be outside the area imprinted by the main pattern (112) and on a periphery of the substrate (130). However, this is not necessarily the case.

As in the example of FIG. 1A, a mold (110) is used that includes a main pattern (112) and an additional imprint feature or stamp (120). When the mold (110) is forced against the substrate (130), as indicated by the arrow (105), the pattern (112) forms a desired structure in the surface (132) of the substrate (130) and the additional imprint feature (120) forms a pattern in the magnetic material pad (122). This pattern, being formed in the magnetic material pad (122), is the desired pattern of magnetic material on the substrate (130).

As will be appreciated by those skilled in the art, the two preceding examples pertain to forming a pattern of magnetic material on a substrate in the context of imprint lithography. FIGS. 1A and 1B demonstrate how the process of imprint lithography can lend itself to the additional formation of a pattern of magnetic material on the substrate for subsequent alignment operations. However, the pattern of magnetic material may also be formed on a substrate using similar or other techniques in the context of photographic lithography.

The technique of using a pattern of magnetic material to align a patterning tool and substrate will be described in detail below. It will be clear to those skilled in the art, however, that this technique can be applied with equal utility to both imprint and photographic lithography.

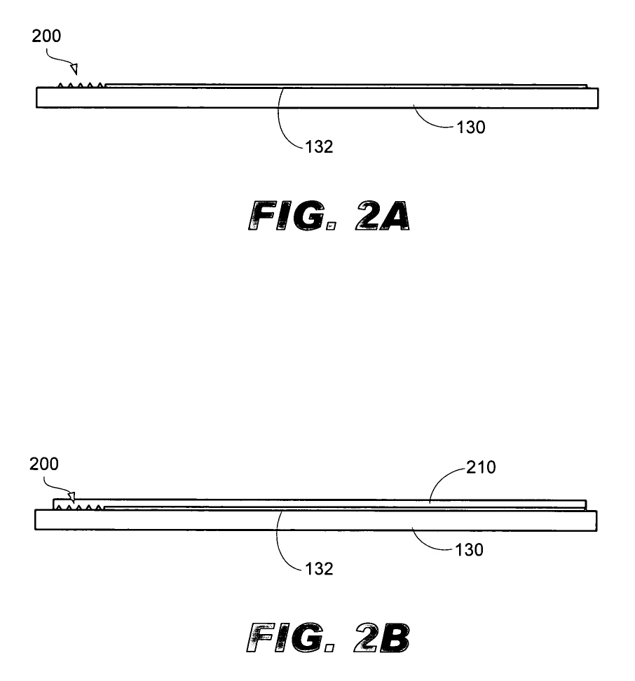

FIG. 2A is a schematic side view of a substrate undergoing contact lithography following the formation of a magnetic alignment pattern, according to one exemplary embodiment. As shown in FIG. 2A, the substrate (130) now includes a pattern (200) of magnetic material. This pattern (200) may be formed by the techniques described above in connection with FIGS. 1A and 1B or other techniques.

As illustrated in FIG. 2A, the pattern (200) is a relief pattern with, for example, troughs and peaks. In some examples, this pattern (200) of magnetic material will have a regular spacing of raised features on the substrate (130).

Due to the relief of this pattern (200) of magnetic material, different magnetic field strengths will occur a set distance above the substrate (130) in the area of the pattern (200). This varying magnetic field will correspond to the high and low points of the pattern (200) or, in other words, the varying distance from that set distance above the substrate to a point on the pattern (200) of magnetic material directly below.

The magnetic field will be relatively strong at points directly above the peaks of the pattern (200) and will decrease in strength to a minimum at points directly above the troughs or valleys of the pattern (200). It is this variation in magnetic field strength that allows the pattern (200) to be used for precise alignment of a mold or other patterning tool with the substrate (130), as will be described in more detail below.

FIG. 2B is a schematic side view of a substrate undergoing contact lithography following the formation of a magnetic alignment pattern and an additional patterning material layer, according to one exemplary embodiment. As shown in FIG. 2B, an additional layer of patterning material (210) has been deposited over the substrate (130). This layer (210) may be a layer of imprint material for receiving a pattern through imprint lithography or the layer (210) may be layer of photoresist or the like for receiving a pattern through photographic lithography.

In the example of FIG. 2B, the layer (210) covers the surface (132) that contains the pattern produced by the first mold (110, FIGS. 1A and 1B) and is used to receive a next pattern from the same or a different mold to form another layer of structure over the underlying layer on the surface (132). As shown in FIG. 2B, this additional layer (210) also covers the patterned magnetic material (200). However this is not necessarily the case.

During alignment, the distance between a mold and substrate being aligned is generally on the order of tens of nanometers. Consequently, the magnetic field created by the patterned magnetic material (200) can be adequately detected even if the pattern (200) is covered under one or more layers of deposited patterning material.

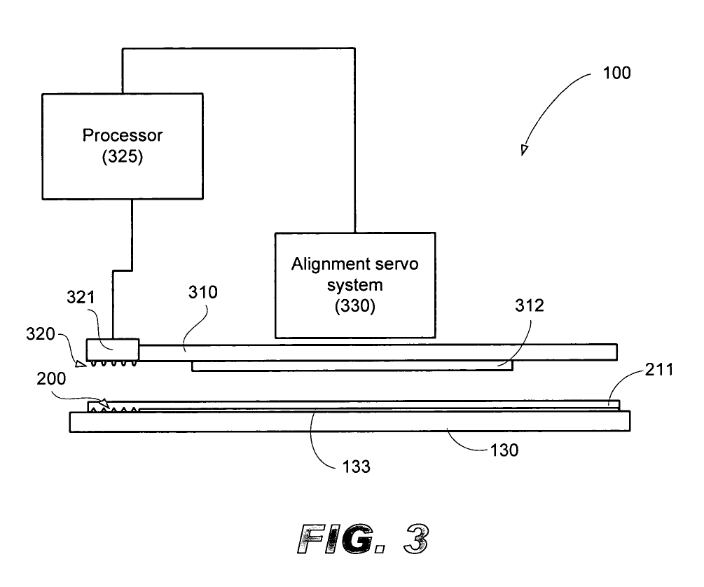

FIG. 3 is a schematic side view of a contact lithography apparatus that is using a pattern of magnetic material on a substrate to align a contact lithography mold with the substrate, according to one exemplary embodiment. As shown in FIG. 3, the substrate (130) has been prepared with a pattern (200) of magnetic material that will be used to align the substrate (130) with a patterning tool (310), such as a mold or mask. The patterning tool (310) includes a pattern (312) that is to be transferred to the substrate (130).

In some examples, the substrate (130) may have an initial patterned layer (133) already formed thereon. In such cases, another layer of patterning material (211) is provided over the initial patterned layer (133) so that a next patterned layer can be formed therein.

A magnetic sensor head (321) is also incorporated with the patterning tool (310). This magnetic sensor head (321) may include a number of magnetic sensors (320) that are sensitive to the local strength of a magnetic field. These sensors (320) may be disposed on the sensor head (321) in a pattern or with a spacing that corresponds to the spacing of relief features in the pattern (200) of magnetic material on the substrate (130). The sensors (320) may be, for example, Giant Magneto Resistance (GMR) sensors.

When the patterning tool (310) is brought into close proximity with the substrate (130), the sensors (320) of the sensor head (321) on the patterning tool (310) will register the varying magnetic field produced by the pattern (200) of magnetic material on the substrate. As described above, features with a relatively high relief, e.g., peaks, in the pattern (200) will produce a stronger magnetic field at the level of the sensor head (321) than do features with a relative low relief, e.g., troughs or valleys.

Consequently, the sensor head (321) will output a maximized signal when, for example, each of the sensors (320) is precisely aligned with a corresponding peak in the pattern (200) of magnetic material. Alternatively, the sensor head (321) will output a minimized signal when the sensors (320) are precisely aligned over the low points of the pattern (200). In this way, precise alignment between the patterning tool (310) and the substrate (130) can be verified.

The sensor head (321) will output a signal to a processor or controller (325). The processor (325) is programmed to interpret the signal from the sensor head (321) as an indication of whether the sensor head (321) is precisely aligned over the pattern of magnetic material (200).

As will be appreciated by those skilled in the art, a number of different methods could be used to verify, using the magnetic field of the pattern (200), that the sensor head (321) and the patterned magnetic material (200) are precisely aligned, for example, when the output of the sensor head (321) is maximized by aligning individual sensors (320) with high points of the pattern (200) of magnetic material.

The processor (325) will accordingly drive an alignment servo system (330). The alignment servo system (330) may be or comprise any system or device able to adjust the relative positions and orientation of the patterning tool (310) and the substrate (130) on a micro or nano-scale.

The alignment servo system (330) may move both the patterning tool (310) and the substrate (130), just the patterning tool (310) or just the substrate (130). In any of these cases, the alignment servo system (330) is able to change and adjust the relative positions and orientation of the patterning tool (310) and the substrate (130). As indicated, the alignment servo system is capable of making very fine adjustments, on the order of nanometers, to the relative positions and orientation of the patterning tool (310) and the substrate (130).

If the output of the sensor head (321) indicates to the processor (325) that the patterning tool (310) and substrate (130) are not properly or completely aligned, the processor (325) will control the alignment servo system (330) to accordingly adjust the relative positions and orientation of the patterning tool (310) and the substrate (130). This process continues until the signal from the sensor head (321) indicates to the processor (325) that the sensor head (321) and the patterned magnetic material (200) are precisely aligned. This is taken to mean that the patterning tool (310), on which the sensor head (321) is disposed, and the substrate (130), on which the magnetic pattern (200) is disposed, are correspondingly precisely aligned.

When this occurs, the processor (325) stops driving the alignment servo system (330). The patterning tool (310) and substrate (130) are then aligned and prepared for a lithographic transfer of the pattern (312) of the patterning tool (310) to the substrate (130), e.g., into patterning material layer (211). As noted, either imprint or photographic lithography may be used to pattern the material layer (211).

After the pattern (312) has been used to form a desired corresponding structure in the patterning material layer (211), the process may be repeated to form as many additional layers of patterning as are desired. Specifically, another layer of patterning material is deposited over the previous layer, e.g., layer (211). The sensor head (321) is then used to again detect the patterned magnetic material (200) and align a patterning tool with the substrate. The pattern of the patterning tool is then lithographically used to form a desired structure on the uppermost layer of material on the substrate (130). As indicated, this process may be repeated to form as many additional layers of patterning as are desired.

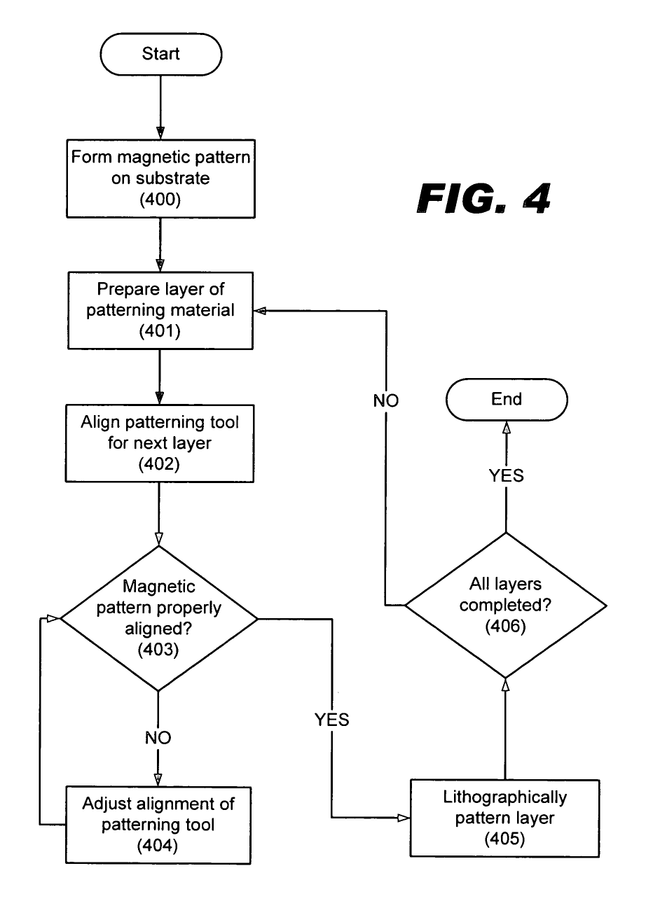

FIG. 4 is a flowchart illustrating a process of fabricating a multi-layer structure using a contact lithography process that aligns a patterning tool for each layer using a pattern of magnetic material formed on the substrate, according to one exemplary embodiment. As shown in FIG. 4, the process begins by forming a magnetic pattern or a pattern in magnetic material on the substrate (step 400). As described above, this can be done through a number of different techniques such as imprinting, printing, selective deposition, etc.

Additionally, a layer of patterning material (step 401) is prepared to lithographically receive a pattern in the form of a desired structure. As indicated above, this layer may be an original, natural surface of the substrate, may be a layer of patterning material deposited on the surface of the substrate or may be a layer of patterning material deposited over a preceding layer of patterning material.

Next, the patterning tool that will form the desired the structure in the layer of material is registered over the substrate. As indicated above, the patterning tool and substrate must be precisely aligned to optimize the production and utility of the device being fabricated.

As described above, a pattern of magnetic material on the substrate produces a spatially varying magnetic field that can be detected by a corresponding sensor head to determine the alignment between the patterning tool and the substrate (step 402). The alignment between the patterning tool and the substrate, as indicated by detection of the magnetic field of the patterned magnetic field, is compared to some standard that indicates that the patterning tool and substrate are properly aligned. This standard may be, for example, a particular signal strength, such as a maximized signal strength, produced by the magnetic sensor head when the sensor head is precisely aligned with the pattern in the magnetic material.

If the magnetic pattern and sensor head are properly aligned (determination 403), the corresponding patterning tool and substrate are considered to be properly and precisely aligned. The pattern on the patterning tool is then lithographically transferred to the pattern-receiving layer or surface of the substrate to form a desired structure therein (step 405).

If, however, the magnetic pattern and sensor head are not properly aligned (determination 403), an alignment system, such as the servo system described above, will be used to adjust the relative positions and orientation of the patterning tool and substrate (step 404). The alignment of the magnetic pattern with the sensor head is then again determined (determination 403).

This loop of the method shown in FIG. 4 can be repeated as needed to bring the patterning tool and substrate into proper alignment. As will be appreciated by those skilled in the art, this loop of adjusting the alignment, determining the degree of desired alignment and making further adjustments and tests as needed can be automated to most efficiently conduct the desired lithographic production process.

After a layer has been lithographically patterned (step 405), the determination is made whether all the desired layers have been completed (determination 406). As indicated herein, a number of patterned layers may be stacked to produce a desired device.

If all the desired layers have been completed (determination 406), the method ends. If, however, additional layers are desired, another layer of patterning material is prepared or deposited on the substrate (step 401). The following steps of the method are then repeated. Specifically, the patterning tool and substrate are aligned (step 402), the alignment is verified (determination 403), the current layer is lithographically patterned (step 405) until all desired layers are completed (determination 406).

The preceding description has been presented only to illustrate and describe examples of the principles discovered by the applicants. This description is not intended to be exhaustive or to limit these principles to any precise form or example disclosed. Many modifications and variations are possible in light of the above teaching.

What is claimed is:

1. A contact lithography system comprising:
a patterning tool having a pattern for transfer to a substrate; and
a sensor disposed on said patterning tool for sensing a magnetic pattern disposed on said substrate to determine alignment between said patterning tool and said substrate.

2. The system of claim 1, wherein said sensor comprises a sensor head having a plurality of individual sensors responsive to magnetic field strength.

3. The system of claim 2, wherein said individual sensors correspond spatially to features of said magnetic pattern on said substrate.

4. The system of claim 1, wherein said sensor is communicatively coupled to a processor that determines said alignment between said patterning tool and said substrate based on a signal from said sensor.

5. The system of claim 4, further comprising an alignment servo system communicatively coupled to said processor, wherein said processor drives said servo system to adjust relative positions and orientation of said patterning tool and substrate to align said patterning tool and substrate.

6. The system of claim 1, wherein said patterning tool comprises an imprint mold.

7. The system of claim 6, wherein said imprint mold comprises an imprint feature for forming said magnetic pattern on said substrate.

8. The system of claim 7, wherein said imprint feature is loaded with a magnetic material to be transferred to said substrate to form said magnetic pattern.

9. The system of claim 7, wherein said substrate comprises a magnetic material pad from which said magnetic pattern is formed using said imprint feature.

10. A method of aligning a patterning tool of a contact lithography system with a substrate, said method comprising detecting a pattern of magnetic material on said substrate with a sensor on said patterning tool to determine alignment of said patterning tool with respect to said substrate.

11. The method of claim 10, further comprising forming said pattern of magnetic material with an imprint feature on said patterning tool.

12. The method of claim 11, further comprising loading said imprint feature with a magnetic material for transfer to said substrate.

13. The method of claim 11, further comprising imprinting a pad of magnetic material on said substrate with said imprint feature of said patterning tool.

14. The method of claim 11, further comprising forming a structured layer on said substrate using a main pattern of said patterning tool at a same time as said pattern of magnetic material is formed.

15. The method of claim 10, further comprising:
adjusting relative positions and orientation of said patterning tool and substrate to achieve a desired alignment between said patterning tool and said substrate using detection of said pattern of magnetic material; and
forming a structured layer on said substrate using a main pattern of said patterning tool.

16. The method of claim 15, further comprising:
depositing a layer of patterning material on said substrate;
aligning said substrate with a patterning tool; and
forming another structured layer in said newly-deposited layer of patterning material.

17. The method of claim 15, wherein adjusting said relative positions and orientation comprises moving said substrate relative to said patterning tool, moving said patterning tool relative to said substrate or moving both said patterning tool and said substrate to achieve said desired alignment.

18. A system for aligning a patterning tool of a contact lithography system with a substrate, said system comprising:
means for detecting a pattern of magnetic material on said substrate, said means for detecting being disposed on said patterning tool; and
means for determining an alignment of said patterning tool with respect to said substrate based on detection of said pattern of magnetic material.

19. The system of claim 18, further comprising means for forming said pattern of magnetic material disposed on said patterning tool.

20. The system of claim 18, further comprising means for adjusting relative positions and orientation of said patterning tool and substrate to achieve a desired alignment between said patterning tool and said substrate using detection of said pattern of magnetic material.

21. The system of claim 20, further comprising means for forming a structured layer on said substrate using said patterning tool.

22. The system of claim 21, further comprising:
means for depositing a layer of patterning material on said substrate; and
means for forming another structured layer in said newly-deposited layer of patterning material.
